(19) United States
(12) Patent Application Publication
(10) Pub. No.: US 2010/0090022 A1
(43) Pub. Date: Apr. 15, 2010

(54) Fragrance device

(76) Inventor: Masamichi Hayashida, Tokyo (JP)

Correspondence Address: Quinn Emanuel Urquhart Oliver & Hedges, LLP;Koda/Androlia, 10th Floor, 865 S. Figueroa Street, Los Angeles, CA, 90017, US

(21) Appl. No.: 12/587,585

(22) Filed: Oct. 9, 2009

(30) Foreign Application Priority Data
Apr. 21, 2008 (JP) 2008-132486

(51) Int. Cl. B05B 1/08

(52) U.S. Cl. 239/99

(57) ABSTRACT

A fragrance device, wherein, a fan, plural number of fragrance material case containing therein fragrance materials, and fragrance selector are installed in a cylindrical container. And, the fragrance device furnishes the characteristic fragrance into the room of motorcar, house or office, by means of the fragrance material cases and fragrance selector being rotated by the air flow exhaled out of the air-conditioning units equipped in the same room.

### BACKGROUND OF THE INVENTION

This invention relates to a fragrance device to be useful in a room of motorcar, house or office.

It is getting popular that the various kinds of fragrance are used in the room of motorcar, house or office in order to eliminate stale odor or to find the pleasure of smelling fragrance itself. In most cases, however, the fragrance will be furnished in an easier or simpler way, like just putting beside a receptacle containing the liquefied or solid fragrance, then there will occur such a phenomenon that the fragrance causes a person's olfactory nerves to be dull sooner or later because of ‘adaptation of fragrance’ so-called as far as the monotonous or immutable fragrance is smelled continuously.

Under such circumstances, this invention is to pursue that a fragrance device is to provide with some particular function that the characteristic fragrance is furnished to intercept such ‘adaptation of fragrance’ so that the people will not only be released from a sort of stale odor, but also be brought themselves to more pleasant surroundings.

### SUMMARY OF THE INVENTION

It is common nowadays that the room of motorcar, house or office is provided with various kinds of fragrance device, however, in most cases, just monotonous or immutable fragrance will be obtainable from the existing fragrance devices. Then, the fragrance device (called “Device” hereunder) of this invention (called “Invention” hereunder) is to provide with some particular function that the characteristic fragrance (called “Fragrance” hereunder) is provided to intercept such ‘adaptation of fragrance’ as mentioned above.

In order to achieve the above purpose, it is devised by the Invention that the Device being based in a cylindrical container is equipped with a fan, plural number of fragrance material case containing respectively the different kinds of fragrance material and a fragrance selector, and that the fragrance material cases and the fragrance selector are to be rotated by the air flow (called “Air” hereunder) exhaled out of the air-conditioning units (called “Units” hereunder) equipped in the room of motorcar, house or office (called “Room” hereunder).

As a result, the Fragrance is furnished intermittently into the Room by way of the fragrance material cases being rotated by the Air, and also a sort of simple or compound (cocktail) Fragrance is furnished alternatively into the Room by way of the fragrance selector being adjusted to synchronize with the fragrance material cases.

### BRIEF DESCRIPTION OF THE DRAWINGS

FIG. 1 is the general arrangement and vertical cross-sectional view of the Device according to the present invention.

FIG. 2 is a cross-sectional top view of the Device, showing the function of the fragrance material cases and fragrance selector for a sort of cocktail fragrance.

FIGS. 3 (a) and 3(b) are cross-sectional top views of the Device, showing the function of the fragrance material cases and fragrance selector for a sort of simple fragrance.

### DESCRIPTION OF THE PREFERRED EMBODIMENTS

The examples of the Invention are described in detail, referring to the drawings as follows:

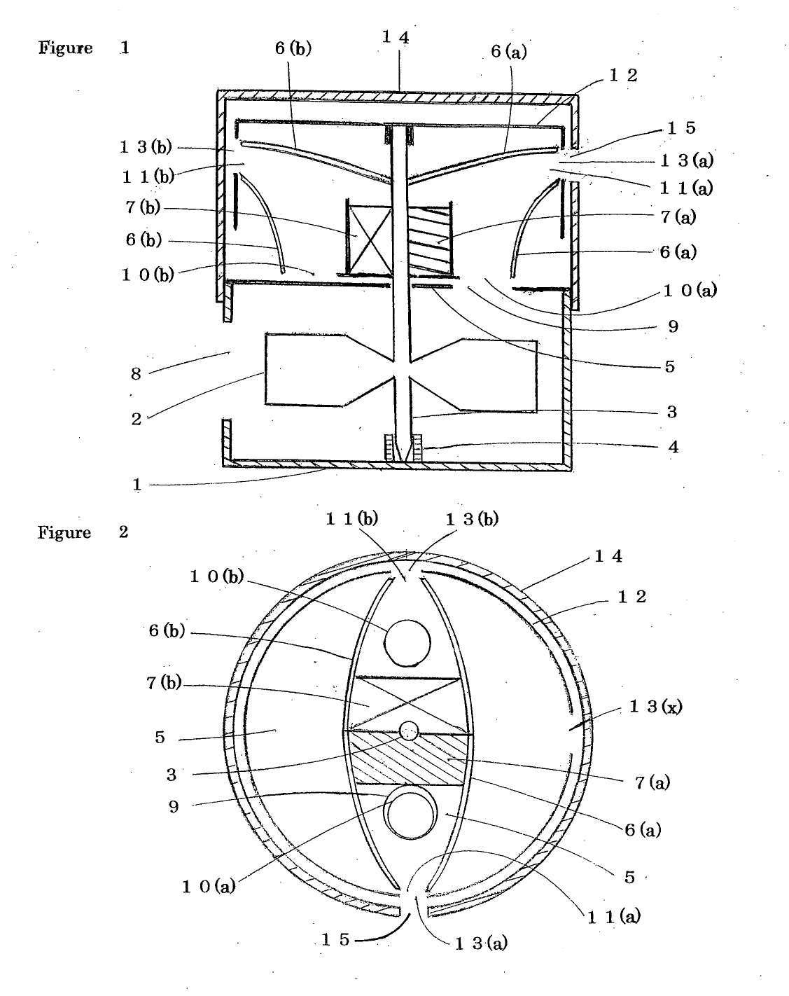

As shown in FIG. 1, the Device, which is based in a cylindrical container, is composed of fragrance device base 1 (called “Base” hereunder), fan 2 (called “Fan” hereunder), fan axis 3 (called “Axis” hereunder), fan socket 4 (called “Socket” hereunder), division 5 (called “Division” hereunder), fragrance material cases 6 (called “Cases” hereunder), fragrance selector 12 (called “Selector” hereunder), and fragrance device cap 14 (called “Cap” hereunder).

As shown in FIG. 1, Division 5 is united to Base 1 and plays roll of another fan socket, and Cases 6 contain therein fragrance materials 7 (called “Materials” hereunder).

As shown in FIG. 1, Cases 6 are covered with Selector 12, further Selector 12 and Base 1 are covered with Cap 14.

As shown in FIGS. 1 and 2, Cases 6 are pluralized (called “Case 6a” and “Case 6b” hereunder), wherein, the different kinds of fragrance material (called “Material 7a” and “Material 7b” hereunder) are contained respectively.

As shown in FIGS. 1 and 2, the Air exhaled out of the Units is to be inhaled into Base 1 and be sent into the Room through Division 5, Cases 6, Selector 12 and Cap 14. Therefore, the inhaling and/or diffusing vents are equipped respectively with Base 1 (called “Base Inhaler 8” hereunder), Division 5 (called “Division Diffuser 9” hereunder), Case 6a (called “Case Inhaler 10a” and “Case Diffuser 11a” hereunder), Case 6b (called “Case Inhaler 10b” and “Case Diffuser 11b” hereunder), Selector 12 (called “Selector Diffuser 13a”, “Selector Diffuser 13b” and “Selector Diffuser 13x” hereunder), and Cap 14 (called “Cap Diffuser 15” hereunder).

As shown in FIGS. 1 and 2, Cases 6 are united to Fan 2 through Axis 3, which are rotated together by the Air, and also Selector 12 is rotated together with Cases 6, provided that Selector 12 is adjustable manually to move around Cases 6 so that Selector Diffuser 13a/13b/13x and Case Diffuser 11a/11b are to be synchronized as mentioned below.

As shown in FIGS. 1 and 2, Division Diffuser 9 and Cap Diffuser 15 are not be rotated with Case 6 and Selector 12, but to be fixed at the same angle each other for harmonious flow of the Air into the Room, so that the Air is to be sent into the Room through the Device, only when Case Inhaler 10a or 10b, Case Diffuser 11a or 11b and Selector Diffuser 13a or 13b or 13x are rotated synchronously and come to the same angle as Division Diffuser 9 and Cap Diffuser 15.

As shown in FIGS. 1 and 2, in the course of the Air being flowed through the Device, the Fragrance emitted in Case 6a and/or 6b is sucked out by the Air and is sent into the Room through Case Diffuser 11a or 11b, Selector Diffuser 13a or 13b or 13x and Cap Diffuser 15. As a result, the Fragrance emitted from Material 7a and/or 7b is sucked by the Air and diffused intermittently into the Room in accordance with the rotation of Cases 6.

As shown in FIG. 2, in case of Selector Diffuser 13a being set to accord with Case Diffuser 11a and simultaneously Selector Diffuser 13b being set to accord with Case Diffuser 11b, the Fragrance emitted by Material 7a and Material 7b is sent interchangeably into the Room through Selector Diffuser 13a and Selector Diffuser 13b in accordance with the reciprocal rotations of Case 6a and 6b. Then, a sort of compound (cocktail) Fragrance is diffused into the Room through Cap Diffuser 15.

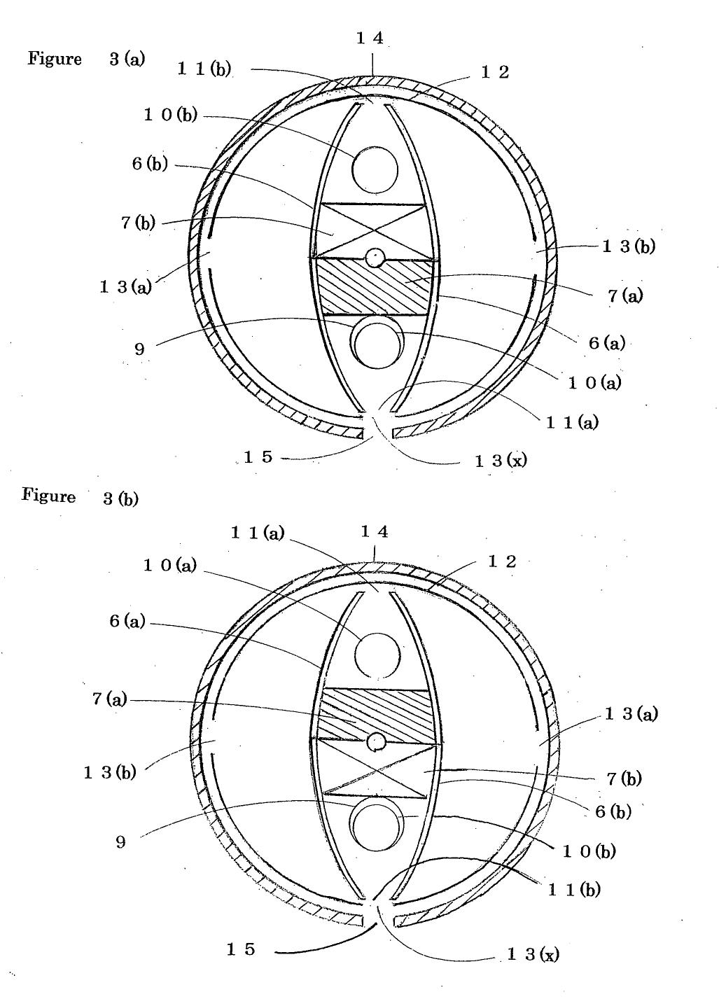

As shown in FIGS. 2 and 3, Selector 12 is equipped with another diffusing vent (called “Selector Diffuser 13x”) in addition to Selector Diffuser 13a and 13b.

As shown in FIG. 3 (a), in case of Selector Diffuser 13x being set to accord with Case Diffuser 11a whereas Case Diffuser 11b being intercepted by Selector 12, the Fragrance emitted by Material 7a only is diffused intermittently into the Room through Cap Diffuser 15 in accordance with the rotation of Case 6a.

As shown in FIG. 3 (b), in case of Selector Diffuser 13x being set to accord with Case Diffuser 11b whereas Case Diffuser 11a being intercepted by Selector 12, the Fragrance emitted by Material 7b only is diffused intermittently into the Room through Cap Diffuser 15 in accordance with the rotation of Case 6b.

Based on the above concept of the Invention, it is possible practically that Cases 6 are increased to more plural number like 3 , 4 or 5, then the kinds of Material 7 are increased to 3, 4 or 5 accordingly and more sophisticated Fragrance is to be furnished by the Device.

In consideration of the Device being mobile or portable, Material 7 is to be provided with a highly absorbent leather or cloth containing the liquid type of Material. The Device is able to be fixed on the Units equipped in the Room by way of a hook, adherent tape or sucker, and so forth.

What is claimed is:

1. A fragrance device comprising a cylindrical container, wherein a fragrance device base, a fan, a division, and plural number of fragrance material case containing therein fragrance materials are to be installed, and in the course of the air exhaled out of the air-conditioning units equipped in the room of motorcar, house or office being flowed through the fragrance device, the fragrance is sucked out of the fragrance material cases and is diffused intermittently into the same room by means of the fragrance material cases being rotated by the said air exhaled out of the air-conditioning units.

2. The fragrance device according to claim 1, wherein, a fragrance selector is installed to cover the fragrance material cases containing respectively the different kinds of fragrance material, and, by means of the fragrance selector being adjusted to synchronize with the fragrance material cases, the fragrance is sucked out of the respective fragrance material cases so that a sort of simple or compound (cocktail) fragrance is diffused alternatively into the room.
